(19) United States
(12) Patent Application Publication
(10) Pub. No.: US 2002/0184388 A1
(43) Pub. Date: Dec. 5, 2002

(54) Layered approach to virtual private routing

(76) Inventors: Nimer Yaseen, Allen, TX (US); Li Mo, Plano, TX (US); Michael J. Mezeul, Allen, TX (US)

Correspondence Address: MUNSCH, HARDT, KOPF & HARR, P.C., INTELLECTUAL PROPERTY DOCKET CLERK, 1445 ROSS AVENUE, SUITE 4000, DALLAS, TX, 75202-2790, US

(21) Appl. No.: 09/978,870

(22) Filed: Oct. 15, 2001

Related U.S. Application Data
(60) Provisional application No. 60/295,136, filed on Jun. 1, 2001.

(51) Int. Cl. G06F 15/173

(52) U.S. Cl. 709/242; 379/901

(57) ABSTRACT

A method of updating routing information related to a virtual private network in a communications network is provided. Routing information is exchanged between a site included in a virtual private network and forwarded to a provider equipment node coupled to a customer equipment node. The routing information is provided to a provider equipment node maintaining a route reflector that distributes the routing information to one or more provider equipment nodes respectively coupled to a customer equipment node that interfaces with a site of the virtual private network.

A network operable to support at least one virtual private network having at least two sites and including a route reflector for distributing routing information updates to provider equipment nodes that include an external virtual private router supporting sites included in the virtual private network is provided. A node for the network is also provided.

### TECHNICAL FIELD OF THE INVENTION

This invention relates to network technologies and, more particularly, a system and method for improving the scalability of networks providing virtual private network services therein.

### BACKGROUND OF THE INVENTION

In FIG. 1, there is illustrated an exemplary connection of networks 100 including nodes 10A-12A in a ring network 30A interconnected by communication links at a geographic site 60. The network is preferably a packet-switched network operable to deliver packetized data between nodes thereof in an appropriately formatted protocol, e.g. IP, User Datagram Protocol (UDP), etc. The network may be embodied with any number of general transmission technologies. Network 100 may be a fiber optic network carrying IP formatted data between nodes 10A-12A. Accordingly, nodes 10A-12A may be implemented as optical transport network nodes. Ring network 30A may be connected to one or more other networks 30B and 30C having nodes 10B-12B and 10C-12C to provide network coverage to a larger geographic coverage area. An intermediate network 30B may be a public network, or other “unsecured” network. Virtual private network (VPN) technologies allow network operators having two or more network sites, such as networks 30A and 30C, located at geographically diverse sites 60 and 70 to interconnect networks 30A and 30C via an intermediate, unsecured network 30B in a private manner, thus alleviating the necessity of expensive dedicated leased lines.

A virtual private network 20 may be provided in the connection of networks 100 for facilitating secure connections through the otherwise unsecured network 30B. VPN 20 connections may be secured through any number of well known techniques, for example by encrypting VPN communications at both ends by firewall software, within routers, etc.

Techniques for supporting VPNs over an underlying common transport architecture are well known. One technique, documented in IETF RFC-2547, ensures segregation of user domain IP address space using a concept of a Route Distinguisher (RD) that, when combined with an IP address, creates a unique address referred to as a VPN-IP address. Additionally, it also uses the concept of a Route Target (RT) to identify related users sharing the VPN. In the methodology detailed in RFC-2547, IP routes to all destinations must be distributed using an Internal Border gateway Protocol (IBGP). An IBGP routing engine stores the VPN-IP addresses and filters routes based on the RTs and/or RDs. This technique eliminates the ambiguity of address spaces between various VPNs utilizing a common, centralized route reflector. However, this technique introduces scalability and performance issues due to the requisite size and quantity of the information necessary to be stored for supporting various VPNs that each require a non-ambiguous address space.

### SUMMARY OF THE INVENTION

In accordance with an embodiment of the present invention, a method of updating routing information related to a virtual private network in a communications network is provided. Routing information is exchanged between a site included in a virtual private network and a customer equipment node interfacing the site with the communications network and forwarded to a provider equipment node coupled to the customer equipment node. The routing information is then provided to a provider equipment node maintaining a route reflector that distributes the routing information to one or more provider equipment nodes respectively coupled to a customer equipment node that interfaces with a site of the virtual private network.

In accordance with another embodiment of the present invention, a network operable to support at least one virtual private network having at least two sites and including a route reflector for distributing routing information updates to provider equipment nodes supporting sites included in the virtual private network is provided. A plurality of sites are included in a virtual private network and each is coupled to a customer equipment node. A plurality of provider equipment nodes including a provider equipment node maintaining the route reflector are included in the network and are respectively coupled to one or more customer equipment nodes. Each of the plurality of provider equipment nodes that is coupled to one of the plurality of customer equipment nodes includes a virtual private network forwarding information base assigned to the virtual private network and that stores routing information of the virtual private network. An external virtual private router for processing routing updates related to the virtual private network is included in each of the provider equipment nodes coupled to a customer equipment node that interfaces a site of the virtual private network.

In accordance with another embodiment of the present invention, a node for a communications network including an external virtual private router is provided. The node includes an interface for connection to a customer equipment node. A virtual private network forwarding information base for storing routing information of a virtual private network supported by the network is included within the node and the external virtual private router processes routing information updates related to the virtual private network topology.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 is a connection of networks including a public network across which other networks may be connected and in which the present invention may be implemented for advantage;

FIG. 2A is a simplified representation of a public network operating as a transit network for a virtual private network according to the prior art;

FIG. 2B illustrates the logical equivalent of the virtual private network illustrated in FIG. 2A;

FIG. 3 is a public network that operates as a transit network for exemplary virtual private networks;

FIG. 4 is public network including a route reflector as implemented in the prior art;

FIG. 5 illustrates the processing flow within a provider equipment and the scalability problems resulting from maintaining updated routing and forwarding information in various VPN-forwarding information bases according to the prior art;

FIG. 6 is a network including a centralized route reflector and three individual ring networks each including various network nodes according to the prior art;

FIG. 7 is an improved connectivity within a network that may be had by utilizing VPN-dedicated route reflectors according to the teachings of the invention;

FIG. 8 is an internal functionality of an external virtual private router maintained by provider equipment nodes according to the teachings of the invention; and

FIG. 9 is a network having VPN-dedicated route reflectors according to the teachings of the invention.

### DETAILED DESCRIPTION OF THE DRAWINGS

The preferred embodiment of the present invention and its advantages are best understood by referring to FIGS. 1 through 9 of the drawings, like numerals being used for like and corresponding parts of the various drawings.

The present invention introduces an External Virtual private Router (EVPR) that, in conjunction with Internal Virtual Private Router (IVPR), partitions the provider domain from the customer domain resulting in a layered solution that is scalable and memory efficient. The EVPR of the invention may support both layer 2 and layer 3 VPNs. In the most general sense, the EVPR provides routing information to a network node including a route reflector (RR) that, in turn, distributes the routing information to other network nodes that support sites included in a common virtual private network (VPN).

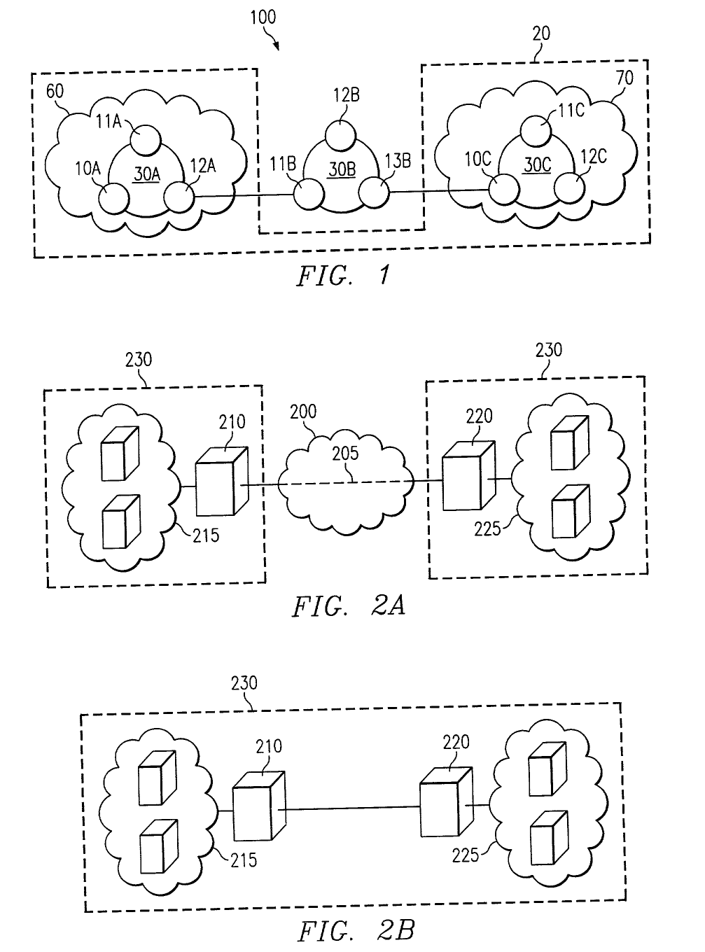

In FIG. 2A, there is illustrated a simplified representation of a public network 200, for example the Internet, operating as a transit network for a VPN 230. As illustrated, implementation of VPN 230 generally requires one or more edge of network VPN servers 210 and 220 to connect one or more networks 215 and 225 via a VPN connection 205 made through the public network 200. The VPN connection 205 appears to a user of either network 215 and 225 as a private network communication although the connection is made over public network 200. VPN connection 205 is generally secured through a number of techniques including user authentication procedures, address management, and encryption. The logical equivalent of VPN 230 is illustrated in FIG. 2B. Networks 215 and 225 may be, for example, corporate LANs. VPN technology is also useful for connecting branch offices to corporate LANs. VPN 230 allows geographically diverse networks 215 and 225 to be securely connected over public network 200. A corporation or other entity may then have the convenience of a private network at a more economical implementation relative to comparable private networks interconnected over expensive leased lines. The configuration illustrated in FIG. 2A is exemplary only. Numerous other configurations exist for implementing a VPN. For example, network 215 and edge of network server 210 may be replaced by a single user, for example a corporate employee accessing a corporate network 225 via a dial up connection and an Internet Service Provider (ISP). In this situation, a VPN allows a remote client to access a private network from a distant site and is useful in such scenarios as telecommuting.

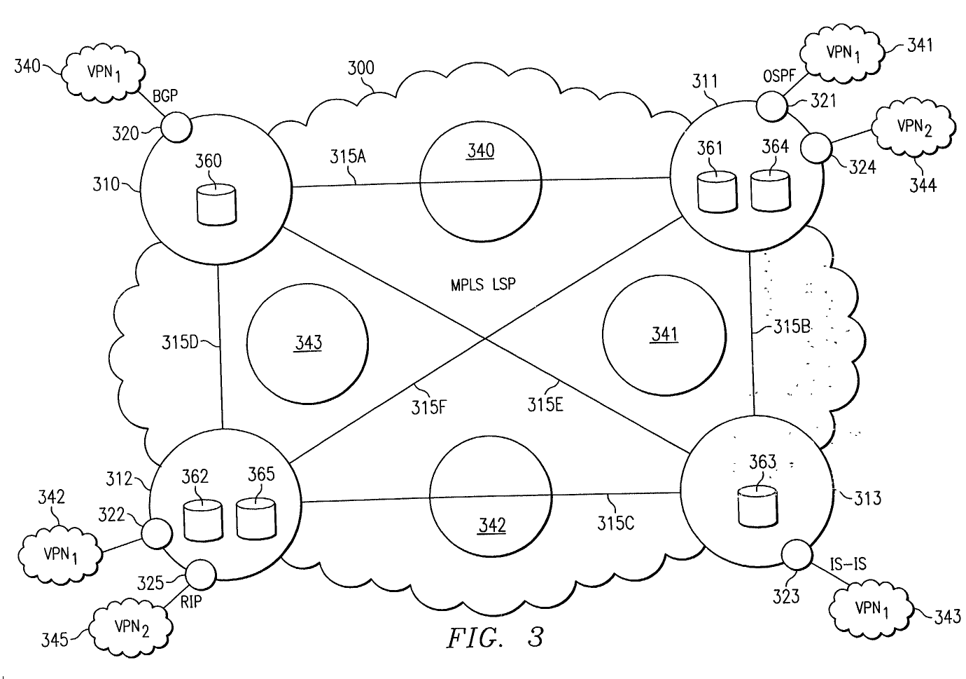

In FIG. 3, there is illustrated a public network 300, such as the Internet, servicing two VPNs (VPN₁ and VPN₂). VPN₁ includes four customer sites 340-343 and VPN₂ includes two customer sites 344 and 345. Each customer site 340-345 is connected to public network 300 via a respective customer equipment node (CE) 320-325 such as a layer 2 switch, an IP router or another device. CEs 320-325 connect to a provider equipment node (PE) 310-313 within public network 300. Each PE 310-313 maintains a VPN forwarding information base (VFIB) 360-365 for each site connected thereto, that is each VFIB 360-365 is associated (via a port of the respective PE 310-313) with a particular VPN such as VPN₁ or VPN₂. Each VFIB includes routing information regarding the customer sites for which the VFIB is maintained. For example, VFIBs 360-363 are associated with VPN₁ and are accordingly maintained in each PE 310-313 that services a site 340-343 included in VPN₁. Likewise, VFIBs 364-365 are associated with VPN₂ and are maintained in PEs 311 and 312 servicing sites 344 and 345 included in VPN₂. Labels may be assigned to routes maintained in each VFIB for facilitating multiprotocol label switching (MPLS). Other routing information may be included in a VFIB, for example labels assigned to a particular PE for allowing establishment of a label switched path between PEs 310-313. One or more ports of each PE 310-313 are associated with a particular VFIB 360-365. Thus, a single VFIB may be used for routing and forwarding information to multiple sites, for example multiple sites of a common VPN accessing public network 300 via a common PE. However, VFIBs are maintained on a per customer, that is per VPN, basis and privacy and segregation of routing information are accordingly provided thereby. Various other provider routers 340-343 that do not have CEs connected thereto are included in the public network for facilitating transmissions throughout public network 300. Generally, provider routers 340-343 only maintain routing information regarding PEs 310-312 and other provider routers 340-343 and detailed routing information regarding CEs 340-345 is not maintained in provider routers 340-343.

PEs 310-313 exchange routing information that is maintained in VFIBs 360-365 regarding customer sites 340-345 with other PEs 310-313 in public network 300. This exchange of routing information may be made according to a border gateway protocol. Connections 315A-315F, for example transmission control protocol (TCP) connections, may be maintained in a mesh configuration between each of PEs 310-313 servicing a VPN. Thus, any modification made to a customer site 340-345, for example modifications to a network therein, results in an update being made to the routing and forwarding information in the corresponding VFIB 360-365. The updated routing and forwarding information, for example one or more updated Internet protocol (IP) routing prefixes, is then forwarded to all PEs 310-313 regardless of whether a particular PE 310-313 receiving the updated information services the VPN responsible for generating the updated routing and forwarding information. PEs 340-345 receiving forwarding and routing information updates then filter this information and modify any relevant VFIBs 360-365 maintained therein. This procedure often results in high volumes of traffic being transported across network 300 and may include large portions thereof that are ultimately unnecessary. For example, a modification to customer site 345 of VPN₂ will result in an update being performed on VFIB 365 maintained in PE 312. This updated routing and forwarding information is then transmitted to PEs 310-311 and 313 over TCP connections 315D, 315F and 315C. However, only VFIB 364 will ultimately be updated in response to changes made to VFIB 365. PEs 310 and 313 that service only VPN₁ will nevertheless receive this updated routing and forwarding information. This information is then subjected to filtering procedures after which it is finally discarded. Public network 300 may service hundreds, or even thousands, of VPNs. As the number of VPNs increases, the amount of unnecessary signaling made in public network 300 related to changes in routing and forwarding information can consume valuable network capacity. Furthermore, the amount of processing overhead at each PE 310-313 required to filter out unnecessary routing and forwarding information can become unmanageable.

Modem public networks 300 may deploy any number of technologies, for example asynchronous transfer mode (ATM) technologies and frame relay, to efficiently utilize the transit network capacities for enabling high speed transmissions of packet routed data such as IP packetized data. Accordingly, public network 300 may implement multiprotocol label switching (MPLS) to facilitate label switched paths (LSP) thereby enabling the combination of layer two switching with layer three routing. Individual customer sites 340-345 included in VPN₁ and VPN₂ may access public network 300 by any one of numerous protocols, for example the Border Gateway protocol (BGP), the Open Shortest Path First (OSPF) Interior Gateway protocol, the Intermediate System—Intermediate System (IS-IS) Interior Gateway protocol, the Routing Intermediate protocol (RIP), etc.

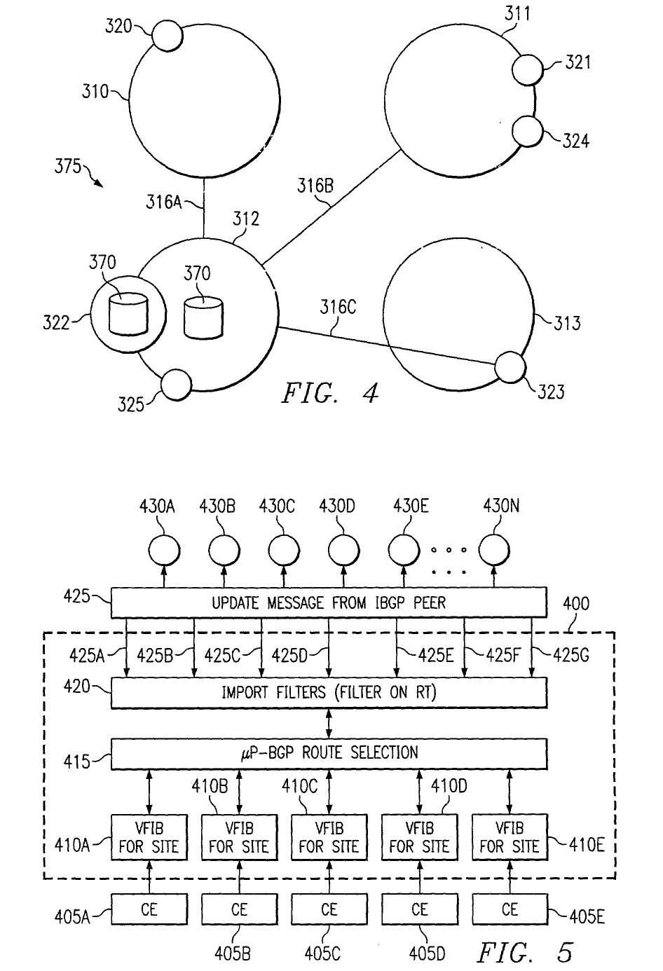

To reduce the abovedescribed undesirable consequences of providing routing and forwarding updates by a mesh configuration of PEs 310-313, a central route reflector (RR) 370 may used to reduce the overall number of TCP connections, as illustrated in FIG. 4. PEs 310-313 transferring BGP data, for example routing information, are required to have a full mesh connectivity, that is any given PE 310-313 must be able to engage any other PE 310-313 in a TCP connection. As described, this may result in a large number of TCP connections between PEs 310-313. RR 370 enables a particular PE 312 to act as a focal point in network 300 from which all PE BGP sessions are terminated. TCP configuration 375 illustrates an alternative to the mesh configuration of connections between PEs 310-312 in the public network 300 illustrated in FIG. 3. TCP configuration 375 is enabled by including RR 370 in network 300 that maintains information on the topology of network 300 such that any PE 310, 311 and 313 connecting to PE 312 hosting RR 370 may access any other PE 310, 311 and 313 through PE 312. The number of connections 316A-316C required is thus reduced. However, the administrative overhead and the requisite processing power at PE 312 that is hosting RR 370 can become intensive. A centralized RR 370 causes severe scalability issues for the provider as well.

FIG. 5 illustrates the processing flow within a PE 400 supporting five CEs 405A-405E and the scalability problems resulting from maintaining updated routing and forwarding information in the various VFIBs of a network servicing VPNs. Each CE 405A-405E serviced by a PE 400 will have a respective VFIB 410A-410E (assuming each CE is associated with a different VPN) maintained in PE 400. Any modification to a site connected to PE 400 via CE 405A-405E results in a modification made to the corresponding VFIB 410A-410E. For example, a network modification in a site accessing PE 400 via CE 405A results in an exchange of routing and forwarding information between CE 405A and PE 400 regarding that particular site. This information exchange is used to update VFIB 410A. A BGP transmission 425 is then made to notify other PEs 430A-430N within the network of the updated routing information regarding changes to the topology of the site accessing PE 400 via CE 405A. Notably, BGP transmission 425 is made to all PEs 430A-430N in the network. Each modification to a site connecting to PE 400 via a CE 405A-405E results in an update message being transmitted to all PEs 430A-430N. PEs 430A-430N each then filter the updated routing information to determine whether or not the site responsible for generating the updated information has a corresponding site serviced by the respective PE 430A-430N, that is PEs 430A-430N evaluate whether or not the site that generated the update information belongs to a VPN serviced by the receiving PE 430A-430N. Routing information updates originating from a site belonging to a VPN not supported by a particular PE 430A-430N receiving the updated routing information are ultimately discarded after filtering. Routing information updates originating from a site belonging to a VPN that is supported by a particular PE 430A-430N receiving the updated routing information are installed into the VFIB associated with the site supported by the receiving PE 430A-430N. In a similar manner, any modification to a site serviced by a PE 430A-430N results in an exchange of updated routing information between the CE (not shown) that connects the site to PE 430A-430N. These updated routes are installed in the associated VFIB and transmitted to all IBGP peers, that is to all other PEs in the network. For example, modifications to a network at a site serviced by PE 430A results in an exchange of routing information between PE 430A and the CE servicing the modified site. The updated routes are installed into the associated VFIB and an IBGP session with PE 400 provides update message 425 to PE 400 regarding routing information modifications of the modified site. Routing information generated by PE 430A and transmitted to PE 400 in an update message 425 is subject to an import policy analysis, for example an analysis by import filters 420. The routing information transmitted in the update message 425 may then be used to update one or more VFIBs 410A-410E, or analysis by import filters 420 may indicate that the routing information in the update message 425 does not include routing information related to any VPN site supported by PE 400 via CEs 405A-405E and results in the routing information in the update message 425 being discarded. This general procedure between PE 430A and PE 400 is performed between PE 430A and PEs 430B-430N as well. Clearly, such a procedure may result in heavy traffic amongst PEs 400 and 430A-430N to maintain updated routing information in PEs 400 and 430A-430N. As the number of VPNs supported by PEs 430A-430N and PE 400 and the number of sites included therein increases, the amount of routing update messages transmitted across the network may increase—much of which is ultimately discarded by the routing update message destinations.

The network traffic issues demonstrated in FIG. 5 are representative of a mesh configuration of TCP connections between PE nodes as illustrated in FIG. 3. Implementation of a centralized RR 370, as described with reference to FIG. 4, may reduce the overall TCP connections, that is the IBGP peer sessions, but results in an even greater IBGP burden and processing requirement on node 312 hosting RR 370.

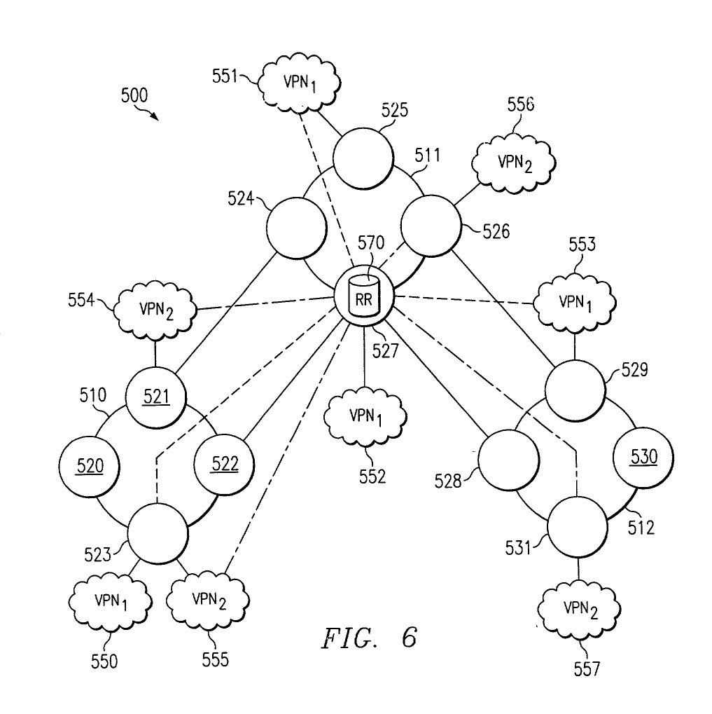

In FIG. 6, there is illustrated a network 500 including a central RR 570 and three individual ring networks 510-512 each including various network nodes 520-531, for example optical transport network nodes. Each network node 520-531 may service one or more VPNs. In the illustrated example, two VPNs (VPN₁ and VPN₂) are serviced by network 500. Specifically, VPN₁ located at customer sites 550-553 is serviced by respective PEs 523, 525, 527 and 529. VPN₂ includes customer sites 554-557 that are serviced by respective PEs 521, 523, 526 and 531. A central RR 570 maintained by PE 527 minimizes the overhead associated with maintaining network connectivity, for example the route reflector 570 can minimize the number of TCP connections required to be maintained by the other PEs 520-526 and 528-531. As illustrated, however, the number of TCP connections required to be supported by PE 527 maintaining RR 570 may become unmanageable because PE 527 must manage all TCP connections between all PEs 520-531 that service any VPN site 550-557 included in network 500. Thus, central RR 570 may be suitable for a limited number of VPNs but is not generally conducive to scalability. The number of VPNs in network 500 may be in the hundreds, or even thousands, thus requiring massive managerial overhead by PE 527 maintaining centralized RR 570.

The present invention resolves the provider's scalability issues by reducing the processing requirements related to managing a route reflector by partitioning the provider domain from the customer domain. An external virtual private router (EVPR) associated with a particular VPN is introduced into network 500 and is included at each node servicing that particular VPN. The EVPR works in conjunction with an internal virtual private router (IVPR) and a route reflector dedicated to a single VPN to provide a layered, scalable solution to VPN provisioning.

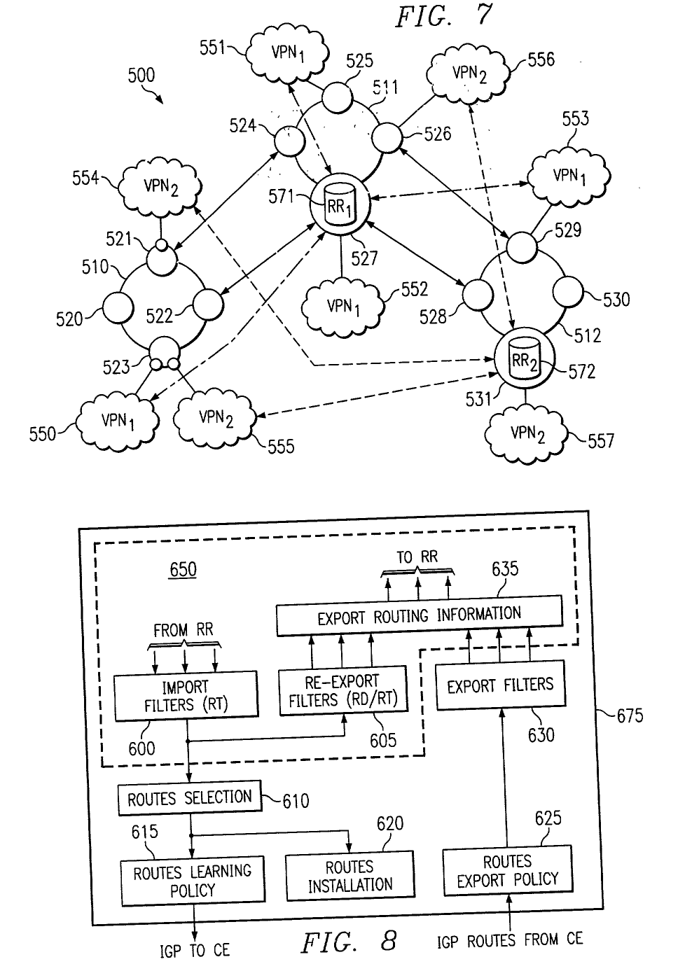

In FIG. 7, there is illustrated an improved connectivity within network 500 that may be had by utilizing RRs 571 and 572 (designated RR1 and RR2) that are respectively dedicated to VPN₁ and VPN₂ according to the teachings of the invention. In the illustrative example, RR 571 is responsible for an administrative domain limited to VPN₁, that is sites 550-553. RR 572 is responsible for an administrative domain limited to VPN₂, that is sites 554-557. By dedicating RRs 571 and 572 to a single VPN, the administrative overhead and the number of TCP connections required to be supported by PEs 527 and 531 maintaining RRs 571 and 572 are reduced in comparison to a PE maintaining a central RR that services all sites 550-557 of all supported VPNs. In addition to a reduction in the administrative overhead required by nodes 527 and 531 maintaining RRs 571 and 572, maintenance traffic associated with forwarding routing information updates regarding VPN₁ and VPN₂ is reduced on network 500 by eliminating routing information updates to PEs that do not support a site of a VPN associated with a particular routing information update. In prior art networks having a single RR 570 (FIG. 6) responsible for administrative functions associated with the various VPNs serviced thereby, any change in a VPN configuration, such as expansion of VPN₁, results in corresponding modification to the routing information maintained in RR 570. This information is then forwarded to all PEs 521, 523, 525-527, 529 and 531 that support a site 550-557 included in any VPN supported by network 500. Referring again to FIG. 6, a modification to a portion of the VPN₁ at site 550 would result in a routing information update message being transmitted to RR 570 so that information therein would accurately indicate the topology of VPN₁. This information is then transmitted to all PEs servicing any site of all VPNs. PEs receiving this information that do not service a site of the VPN₁ are required to filter this information and accordingly discard it. For example, each of PEs 521, 523, 525-527, 529 and 531 would receive updated routing and forwarding information regarding site 550 even though only PEs 523, 525, 527 and 529 service VPN₁. Accordingly, PEs 521, 526, and 531 must filter out this information after an analysis indicating that this information is not relevant to servicing VPN₂ has been made. Referring again to FIG. 7, network 500 of the present invention eliminates unnecessary signaling therein by limiting signaling associated with a VPN only to PEs servicing a site of that particular VPN. This is accomplished through the use of VPN-dedicated RRs 571 and 572.

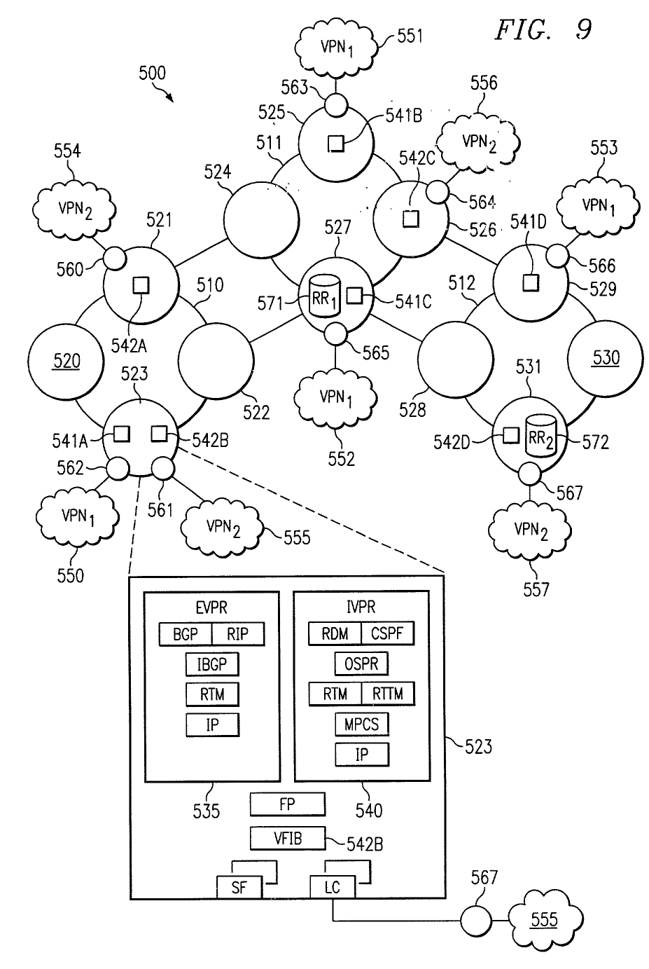

In FIG. 8, there is illustrated an internal functionality of an EVPR 675 maintained by PEs according to the teachings of the invention. An instance of EVPR 675 is maintained in any PE servicing a site of a particular VPN, that is an EVPR 675 is a VPN-dedicated module. In the illustrated example, EVPR 675 is associated with VPN₁ and is included in PEs 523, 525, 527, and 529 in network 500 (FIG. 7) that respectively support sites 550-553 of VPN1. Likewise, an instance of another EVPR associated with VPN₂ would be maintained in PEs 521, 523, 526, and 531. EVPR 675 is responsible for initial processing of updated routing information received from a VPN-dedicated RR 571 that services VPN₁ to which EVPR 675 is likewise 5 dedicated. Any routing information updates transmitted from a PE 523, 525, 527 and 529 to VPN-dedicated RR 571 is forwarded to all other PEs 523, 525, 527 and 529 also servicing sites included in VPN₁. Updated routing information received at each PE results in each instance of EVPR 675 performing a filter import process 600. A routes selection process 610 is then performed and results in the installation of the updated routing and forwarding information (block 620), for example in the VFIB respectively maintained in each PE running EVPR 675.

When EVPR 675 receives routing information updates from a RR, for example VPN-dedicated RR 571, this information may be immediately re-exported (block 605) and transmitted to one or more RRs. This step is unnecessary when only VPN-dedicated RRs are included in network 500. However, to ensure interoperability with prior art RRs and legacy equipment, the ability to re-export routing information updates by EVPR 675 ensures that non-dedicated RRs will have updated routing information regarding sites of VPN₁ serviced by EVPR 675.

EVPR 675 is also responsible for acquiring and processing routing information from sites of VPN₁ that are connected to the PE maintaining EVPR 675. An IGP session provides an exchange mechanism for exporting routes from a CE connecting a site of VPN₁ to the PE maintaining EVPR 675. These routes are exported (block 625) and filter exports 630 are derived and exported therefrom (block 635) to VPN₁-dedicated RR 571. To ensure compatibility with non-dedicated RRs, filter exports may also be transmitted to PEs operating non-dedicated RRs.

In FIG. 9, there is illustrated network 500 having RRs 571 and 572 (designated RR1 and RR2) that are respectively dedicated to VPN₁ and VPN₂ according to the teachings of the invention. In the illustrative example, RR 571 is responsible for an administrative domain limited to VPN₁, that is sites 550-553. RR 572 is responsible for an administrative domain limited to VPN₂, that is sites 554-557. In addition to a reduction in the administrative overhead required by PEs 527 and 531 maintaining RRs 571 and 572, unnecessary routing information update traffic associated with the VPNs is reduced on network 500. Unnecessary signaling in network 500 is reduced by limiting signaling associated with a particular VPN only to PEs servicing a site of that particular VPN. This is accomplished through the use of the aforedescribed VPN-dedicated RRs 571 and 572 and the EVPR entity taught by the invention.

Each site 550-557 interfaces a respective PE via a CE 560-567. Site 555 included within VPN₂ accesses PE 523 via CE 561. VPN₂ routing information must be distributed amongst PEs 521, 523, 526 and 531 servicing respective sites 554-557 of VPN₂ prior to a site, for example site 555, being able to transmit and receive traffic to and from other sites 554 and 556-557 commonly belonging to VPN₂. Routing information must likewise be distributed among PEs 523, 525, 527 and 529 when site topologies are modified that result in routing changes in any of sites 550-553 included in VPN₁. In the present illustrative example, a modification is made to site 555 resulting in routing information, such as an Ipv4 routing prefix, being provided to PE 523 by CE 561 via any one of numerous routing protocols, for example RIP, OSPF, etc. The routing information is subjected to an import policy such as RT filtering (by import filters 600 as described with reference to FIG. 8) by PE 523. If the routing information is passed by the import policies of PE 523 associated with VPN₂, the route is installed in local VFIB 542B (maintained within PE 523 for servicing site 555 of VPN₂) as an IP route. A label, such as a MPLS label, is preferably assigned to the route (and installed therewith in VFIB 542B) received by PE 523 from local CE 561 prior to distributing the route to PEs 521, 526 and 531 via RR₂ 572 for facilitating LSP transmissions across network 500. EVPR 535 then converts the route prefix to a virtual private network-IP (VPN-IP) prefix using route distinguishers configured and associated with VFIB 542B. EVPR 535 then transmits the VPN-IP prefix of the route, as well as the address of PE 523 and the MPLS label assigned to the route, to PE 531 maintaining RR 572 dedicated to performing route reflection for VPN₂. Additionally, one or more filters, for example a route target attribute, may be exported along with the route prefix transmission and label to RR 572 as described with reference to FIG. 8. PE 531 maintaining RR 572 then forwards the routing information, including the MPLS label and the RT, to PEs 521 and 526 that service sites 554 and 556 included in VPN₂. The routing information received by PEs 521, 526 and 531 may then be subjected to import policies associated with all VFIBs maintained at the particular PE 521, 526 and 531. For example, the routing information originally transmitted by PE 523 and forwarded to PE 521 via PE 531 may be subjected to the import policy maintained by PE 521 and associated with VFIB 542A. Likewise, PEs 526 and 531 subject the received routing information to import policies respectively assigned to VFIBs 542C and 542D. If the routing information passes the import policy respectively associated with VFIBs 542A, 542C and 542D at PEs 521, 526 and 531, the routing information is then installed in VFIBs 542A, 542C and 542D. Installation of the routing information in VFIBs 542A, 542C and 542D may take place after installation into a VPN-IP table (not shown) respectively maintained in each PE 521, 526 and 531. Whereas VFIBs 542A-542D maintain only routing information related to sites 554-557 included in VPN₂, a VPN-IP table may be maintained on each PE servicing a VPN site 550-557 and includes routing information related to any sites 550-557 included in any VPNs (1 and/or 2) supported by the particular PE. For example, a VPN-IP table may be required to be maintained at PE 523 and include routes of both sites 550 and 555 respectively included in VPN1 and VPN2. Installation of routes into the VPN-IP table may include RDs to ensure globally unique addresses between overlapping IP address space between different VPNs as is understood in the art. Route selection is also performed in the VPN-IP table prior to installation of routes into VFIBs 542A-542D. The route target transmitted with the route may also be used by the VPN-IP table when performing route selection prior to installation of a route into VFIB 542A-542D. Accordingly, only PEs 521, 523, and 526 must be maintained as IBGP peers of PE 531 hosting VPN₂-dedicated RR 572. In a similar manner, VPN₁-dedicated RR 971 has only PEs 523, 525, 527 and 529 with which IBGP sessions are required for maintaining updated routing information within VFIBs 541A-541D regarding various sites of VPN₁.

Once the routing information has been installed in VFIBs 542A-542D, VPN data traffic may be exchanged between sites 554-557 of VPN₂ as generally described below. In the present example, site 556 desires to transmit VPN traffic to site 555. A host in site 556 forwards VPN data traffic to local CE 564 which, in turn, forwards the VPN traffic to PE 526. PE 526 then executes a route interrogation of VFIB 542C. The MPLS label that was transmitted with the route when it was distributed from PE 523 to PEs 521, 526 and 531, as well as the address of PE 523, are obtained from interrogation of VFIB 542C. An initial label for facilitating allocation of a LSP from PE 526 to PE 523 may also be obtained from interrogation of VFIB 542C as well. The VPN data traffic is then forwarded from PE 526 to PE 523 across network 500 via a LSP. When PE 523 receives the VPN traffic, the data may be converted to an IP packet and forwarded to CE 561 whereupon it is ultimately forwarded to a server in site 555.

While the present invention contemplates an implementation on an optical network, the invention as described herein is not intended to be limited thereto and, accordingly, the network may be any type of network capable of packet-switched data transmissions between various nodes thereof. It will be understood by those skilled in the art that various changes, alterations, modifications, mutations and derivations in form and detail may be made without departing from the spirit and scope of the invention.

What is claimed is:

1. A method of updating routing information related to a virtual private network in a communications network, comprising:
exchanging routing information between a site included in a virtual private network and a customer equipment node interfacing the site with the communications network;
forwarding the routing information to a first provider equipment node coupled to the customer equipment node;
providing, by the first provider equipment node, the routing information to a provider equipment node maintaining a route reflector; and
distributing, by the provider equipment node maintaining the route reflector, the routing information to at least one provider equipment node coupled to a respective customer equipment node that interfaces with a site of the virtual private network.

2. The method according to claim 1, further comprising subjecting the routing information received by the at least one provider equipment node to an import policy assigned to a virtual private network forwarding information base respectively maintained in the at least one provider equipment node.

3. The method according to claim 1, further comprising installing the routing information into a virtual private network forwarding information base respectively maintained in the at least one provider equipment node, the virtual private network forwarding information base associated with the site of the virtual private network that interfaces with the customer equipment node coupled to the at least one provider equipment node that receives the routing information from the provider equipment node maintaining the route reflector.

4. The method according to claim 3, wherein installing the routing information into the virtual private network forwarding information base maintained in the at least one provider equipment node further comprises installing an Internet protocol route in the virtual private network forwarding information base.

5. The method according to claim 1, wherein distributing the routing information further comprises distributing at least one of a route target, a route distinguisher, and a label to the provider equipment node.

6. The method according to claim 1, wherein providing the routing information to the provider equipment node maintaining the route reflector further includes providing, by an external virtual private router maintained in the first provider equipment node, the routing information to the provider equipment node maintaining the route reflector, the external virtual private router assigned to the virtual private network that includes the site coupled to the customer equipment node coupled to the first provider equipment node.

7. The method according to claim 1, wherein providing the routing information to the provider equipment node maintaining the route reflector further comprises providing a virtual private network-Internet protocol route to the provider equipment node maintaining the route reflector.

8. A network operable to support at least one virtual private network having at least two sites, comprising:
a plurality of sites included in a virtual private network;
a plurality of customer equipment nodes each coupled to one of the plurality of sites; and
a plurality of provider equipment nodes including a provider equipment node maintaining a route reflector, each customer equipment node coupled to one of the plurality of provider equipment nodes, each of the plurality of provider equipment nodes that is coupled to one of the plurality of customer equipment nodes respectively including a virtual private network forwarding information base assigned to the virtual private network that stores routing information of the virtual private network, each of the provider equipment nodes having one of the customer equipment nodes coupled thereto including an external virtual private router for processing routing updates related to the virtual private network.

9. The network according to claim 8, wherein the route reflector includes routing information regarding each of the provider equipment nodes respectively including the virtual private network forwarding information base assigned to the virtual private network.

10. The network according to claim 8, wherein the external virtual private router includes routing information regarding the provider equipment node maintaining the route reflector.

11. The network according to claim 8, wherein a routing update generated from one of the plurality of sites results in a route prefix transferred from the customer equipment node coupled to the site generating the routing update to the provider equipment node coupled thereto.

12. The network according to claim 11, wherein the route prefix is an Internet protocol routing prefix.

13. The network according to claim 11, wherein the route prefix is subjected to an import policy analysis by the provider equipment node coupled to the customer equipment node that transfers the route prefix thereto, the route prefix installed, after passing the import policy analysis, into the virtual private network forwarding information base maintained in the provider equipment node coupled to the customer equipment node that transfers the route prefix thereto.

14. The network according to claim 12, wherein the external virtual private router included in the provider equipment node having the route prefix transferred thereto converts the route prefix into a virtual private network Internet protocol routing prefix and forwards the virtual private network Internet protocol routing prefix to the provider equipment node maintaining the route reflector, the virtual private network Internet protocol routing prefix being distributed, by the provider equipment node maintaining the route reflector, to the at least one of the provider equipment nodes respectively coupled to the customer equipment node having one of the sites of the virtual private network coupled thereto.

15. The network according to claim 14, wherein the at least one of the provider equipment nodes respectively coupled to the customer equipment node having one of the sites of the virtual private network couple thereto submits the received virtual private network Internet protocol routing prefix to an import policy executed by an external virtual private router therein, the import policy associated with the virtual private network forwarding information base associated with the site coupled to the customer equipment node, the external virtual private router converting the received virtual private network Internet protocol routing prefix to an Internet protocol routing prefix and installing the Internet protocol routing prefix into the virtual private network forwarding information base upon analysis by an import policy.

16. A node for a communications network, comprising:
an interface for connection to a customer equipment node;
a virtual private network forwarding information base for storing routing information of a virtual private network supported by the network; and
an external virtual private router for processing routing information updates related to the virtual private network topology.

17. The node according to claim 16, wherein the external virtual private router is operable to install a routing prefix received from a customer equipment node connected to the interface into the virtual private network forwarding information base.

18. The node according to claim 16, wherein the external virtual private router is operable to address a node having a route reflector associated with the virtual private network.

19. The node according to claim 16, wherein the external virtual private router is operable to convert an Internet protocol routing prefix into a virtual private network Internet protocol routing prefix.

20. The node according to claim 16, wherein the external virtual private router is operable to convert a virtual private network-Internet protocol routing prefix, received by the node from another node coupled thereto, into an Internet protocol routing prefix
